(19) United States
(12) Patent Application Publication
(10) Pub. No.: US 2008/0130877 A1
(43) Pub. Date: Jun. 5, 2008

(54) Method of Performing Secure and Compact Exponentiation for Cryptography

(75) Inventor: Marc Joye, Saint Zacharie (FR)

Correspondence Address: BUCHANAN, INGERSOLL & ROONEY PC, POST OFFICE BOX 1404, ALEXANDRIA, VA, 22313-1404, US

(73) Assignee: Gemplus, Gemenos (FR)

(21) Appl. No.: 11/793,771

(22) PCT Filed: Dec. 9, 2005
(86) PCT No.: PCT/EP05/56663

§ 371 Date: Jun. 22, 2007

(30) Foreign Application Priority Data
Dec. 23, 2004 (FR) 0453168

(51) Int. Cl. H04L 9/30; G06F 7/556

(52) U.S. Cl. 380/30; 708/277

(57) ABSTRACT

The invention relates to a method for secure and compact exponentiation. The inventive method can be applied in the field of cryptology where cryptographic algorithms are used in electronic devices such as chip cards.

The present invention relates to a method for secure and compact exponentiation, with particular applications in the field of cryptography in which cryptographic algorithms are implemented in electronic devices such as chip cards.

Numerous cryptographic algorithms are based on exponentiation calculations, in an algebraic group, of type x^{d} where x and d are a predetermined element and exponent, respectively. This is, in particular, the case of the RSA (Rivest, Shamir and Adleman) algorithm, which is based on exponentiation in the multiplicative group of the ring of integers modulo N, where N is the product of two large prime numbers. The result of the exponentiation can correspond, for example, to an encrypted or decrypted text, or signed or verified data. Other cryptographic algorithms such as the El Gamal or Diffie-Hellman algorithms rely on exponentiation in the multiplicative group of a body or in the group of points of an elliptic curve.

An electronic device provided for executing such an algorithm must contain, in its memory, on the one hand the executory part for raising x to the power of d, and on the other hand the values of x and d.

Different types of exponentiation algorithms exist. Among these, in particular, the “Square and Multiply” binary method is known.

This algorithm takes an element x and an exponent d as inputs, the binary representation of which is:

{d[t−1], d[t−2], . . . , d[1], d[0]}

where d[i] is equal to 0 or 1, and returns the element y=x̂d, which is to say x.x. . . . .x (d times).

The “Square and Multiply” algorithm can be represented as follows:

| 1) | Initialise register R0 to 1 and register | |
|---|---|---|
| | R1 to x | |
| 2) | For i from t−1 to 0, do | |
| | a) R0 = R0\hat{ }2 | [square]; |
| | b) if d[i] = 1, then | |
| | carry out R0 = R0 * R1 | [multiplication]; |
| 3) | Return R0. | |

Other exponentiation algorithms are known, such as the Jacobi method, known as M, M³, the sliding window method, etc. However, these algorithms are more complex to implement and consequently less suitable for limited electronic components of chip-card type. In the rest of the description, the electronic component comprises a main central processing unit and a working memory with at least three registers (R0, R1, R2)

The “Square and Multiply” algorithm (and the algorithms mentioned above) must include counter-measures which are adapted or, in other words, secured, against attacks which aim to see the data contained and manipulated in the processes performed by the calculation device. In particular, counter-measures are provided against so-called simple or differential hidden channel attacks. Simple or differential hidden channel attack is understood to mean an attack based on a physical magnitude that can be measured from outside the device, using direct analysis (simple attack) or statistical analysis (differential attack) to reveal the data contained and manipulated in the processes of the device. These attacks therefore make it possible to reveal confidential information. These attacks were disclosed in particular by Paul Kocher (Advances in Cryptology—CRYPTO'99, vol. 1966 de Lecture Notes in Computer Science, pp. 388-397. Springer-Verlag, 1999). Among the physical magnitudes that can be exploited for this purpose are current consumption, electromagnetic field, etc. These attacks are based on the fact that the manipulation of a bit, which is to say its processing by a specific instruction, leaves a particular fingerprint on the physical magnitude in question according to its value.

The aforementioned exponentiation algorithms have had to include counter-measures for preventing these attacks from succeeding. For example, the “Square and Multiply Always” algorithm is a secure version of the “Square and Multiply” algorithm, in which the operation was conditional on the value of the bit currently being processed, thus allowing hidden channel attacks.

This algorithm takes an element x and an exponent d as inputs, the binary representation of which is:

{d[t−1], d[t−2], . . . , d[1], d[0]}

where d[i] is equal to 0 or 1, and returns the element y=x̂d, which is to say x.x. . . . .x (d times).

The “Square and Multiply Always” algorithm can be represented as follows:

| 1) | Initialise registers R0 and R1 to 1 and | |
|---|---|---|
| | register R2 to x; | |
| 2) | For i from t−1 to 0, do | |
| | a) R0 = R0\hat{ }2 | [square]; |
| | b) b = 1 − d[i]; Rb = Rb * R2 | |
| | | [multiplication]; |
| 3) | Return R0. | |

The “Square and Multiply Always” algorithm is resistant to certain simple attacks (known as SPA or Simple Power Analysis) but it requires an additional register. It is important to note that the R1 register is unnecessary for the calculation itself; it is used to carry out a dummy multiplication when, in iteration i, the bit d[i] of the exponent d is equal to 0 (and, consequently, b=1), so that, regardless of the value of the bit of the exponent d, an iteration i consists of a step of squaring followed by a multiplication.

Unfortunately, although resistant to SPA attacks, the introduction of dummy operations causes another type of weakness. A class of attacks (known as “safe-error attacks”) was introduced by Sung-Ming Yen et Marc Joye (“Checking before output may not be enough against fault-based cryptanalysis”, IEEE Transactions on Computers, vol. 49, pages 967-970, 2000). When applied to the “Square and Multiply Always” algorithm, the idea is to induce a fault during the multiplication operation (step 2b) in iteration 1. If the result of the exponentiation y=x̂d is correct, this means that this multiplication operation was a dummy and, therefore, that the corresponding bit of d is equal to 0 (i.e. d[i]=0). Conversely, if the result of exponentiation is incorrect, this means that the corresponding bit of d is equal to 1 (i.e. d[1]=1). An attacker can thus retrieve the value of the exponent d bit by bit.

The invention relates to an exponentiation method having the same advantages as the “Square and Multiply Always” algorithm, namely resistance to SPA attacks but which, unlike the latter, does not perform any dummy operations.

Furthermore, the method according to the invention has the remarkable special feature of only performing multiplication operations. This is particularly useful in more limited environments such as chip cards, as only the latter operation needs to be implemented, either in software or in hardware.

Thus, this results in the following:
either a saving in terms of the size of code memory (for example ROM or EEPROM) for an implementation in software,
or a saving in terms of circuit size for an implementation in hardware,

because the squaring operation is not necessary.

It should be remembered that on a set with additive notation, such as the group of points of an elliptic curve, the exponentiation is written as Q=d.P, where P and Q are elements of the set with additive notation (elliptic curve) and d is an exponent. This is also the case when working in the additive group of a ring or a body. The general, conventional case is used henceforth, which is to say that multiplicative notation is used, unless explicitly stated otherwise.

In a more detailed manner, the exponentiation method according to the invention is based on the following algorithm.

This algorithm takes an element x and an exponent d as inputs, the binary representation of which is:

{d[t−1], d[t−2], . . . , d[1], d[0]}

where d[i] is equal to 0 or 1, and returns the element y=x̂d, which is to say x.x. . . . .x (d times).

In multiplicative notation, the method according to the invention can be represented in the following manner:

| 1) | Initialise register R0 to 1 and registers R1 | |
|---|---|---|
| | and R2 to x; | |
| 2) | For i from 0 to t−1, do | |
| | a) b = 1 − d[i]; | |
| | b) Rb = Rb * R2 | [1^{st} multiplication]; |
| | c) R2 = R0 * R1 | [2^{nd} multiplication]; |
| 3) | Return R0. | |

The preceding algorithm can evidently be written in additive form. As before, it takes an element P and an exponent d as inputs, the binary representation of which is:

{d[t−1], d[t−2], . . . , d[1], d[0]}

where d[i] is equal to 0 or 1, and returns the element Q=d.P, which is to say P+P . . . +P (d times).

In this case, in additive notation, the method according to the invention can be represented in the following manner:

| 1) | Initialise register R0 to 0 and registers R1 | |
|---|---|---|
| | and R2 to P; | |
| 2) | For i from 0 to t−1, do | |
| | a) b = 1 − d[i]; | |
| | b) Rb = Rb + R2 | [1^{st} addition]; |
| | c) R2 = R0 + R1 | [2^{nd} addition]; |
| 3) | Return R0. | |

In certain algebraic groups, addition with the identity element 0 (equivalent to multiplication by the identity element 1 in multiplicative notation) can behave differently with regard to hidden channel measurements and consequently create a weakness. In this case, the method according to the invention can be easily adapted.

We illustrate the technique for a group with additive notation, such as, for example, the set of points of an elliptic curve. The algorithm begins at iteration i=1 in such a way that none of the registers are initialised with value 0 (known as a point at infinity for an elliptic curve) in the following manner.

Keeping the additive notation, there is a variation according to the invention which can be represented in the following manner:

| 1) | Initialise register R0 and R1 to P and register | |
|---|---|---|
| | R2 to 2.P; | |
| 2) | For i from 1 to t−1, do | |
| | a) b = 1 − d[i]; | |
| | b) Rb = Rb + R2 | [1^{st} addition]; |
| | c) R2 = R0 + R1 | [2^{nd} addition]; |
| 3) | If d[0] = 0 then carry out R0 = R0 − P; | |
| 4) | Return R0. | |

It should be noted that the initialisation of this variation (step 1 above) requires register R2 to contain the value of 2.P. This value can either be pre-calculated or calculated at exponentiation time Q=d.P. In this latter case, if there is no available doubling routine, 2.P can be calculated exclusively through addition by performing ((P+T)+(P−T)) where T is a known element, distinct from P, of the subjacent group, generally an element of the public key.

The exponentiation method of the invention and its variations has the advantage of being resistant to SPA hidden channel attacks and “Safe-Error” attacks, unlike conventional exponentiation algorithms which must include counter-measures to resist these attacks.

Furthermore, and in a notable manner, the exponentiation method of the invention and its variations has the additional advantage of only performing multiplication operations (or addition operations in additive notation).

It is understood that the invention lends itself to several alternative implementation. The description has been made in the context of a chip-card type environment. It is however clear that these instructions can be applied to other applications, such as in computer terminals, network communication terminals and any other electronic device which uses cryptographic calculations.

1. Method for performing exponentiation calculations in an algebraic group with multiplicative notation, of type x to the power of d (x^{d}), where x is an element of said group and d is a predetermined exponent, the binary representation of which is {d[t−1], d[t−2], . . . , d[1], d[0]} where d[i] is equal to 0 or 1, intended for an electronic component comprising a main central processing unit and working memory with at least three registers (R0, R1, R2), said method being characterised in that it returns the element y such that y=x̂d, which is to say x.x. . . . .x (d times), and in that it comprises the following steps:

| 1) | Initialise register R0 to 1 and registers R1 and R2 to x; | |
|---|---|---|
| 2) | For i from 0 to t−1, do: | |
| | a) b = 1 − d[i]; | |
| | b) Rb = Rb * R2 | [1^{st} multiplication]; |
| | c) R2 = R0 * R1 | [2^{nd} multiplication]; |

3) Return R0.

2. Method for performing exponentiation calculations in an algebraic group with additive notation, of type d times P (d.P), where P is an element of said group and d is a predetermined exponent, the binary representation of which is {d[t−1], d[t−2], . . . , d[1], d[0]} where d[i] is equal to 0 or 1, intended for an electronic component comprising a main central processing unit and working memory with at least three registers (R0, R1, R2), said method being characterised in that it returns the element Q such that Q=d.P, which is to say P+P . . . +P (d times), and in that it comprises the following steps:

| 1) | Initialise register R0 to 0 and registers R1 and R2 to P; | |
|---|---|---|
| 2) For i from 0 to t−1, do: | | |
| | a) b = 1 − d[i]; | |
| | b) Rb = Rb + R2 | [1^{st} addition]; |
| | c) R2 = R0 + R1 | [2^{nd} addition]; |

3) Return R0.

3. Exponentiation method according to claim 2, characterised in that it comprises the following steps:

| 1) | Initialise register R0 to P and registers R1 and R2 to 2.P; | |
|---|---|---|
| 2) | For i from 1 to t−1, do | |
| | a) b = 1 − d[i]; | |
| | b) Rb = Rb + R2 | [1^{st} addition] |
| | c) R2 = R0 + R1 | [2^{nd} addition] |
| 3) | If d[0] = 0 then carry out R0 = R0 − P; | |
| 4) | Return R0. | |

4. Exponentiation method according to claim 3, characterised in that the double of element P (2.P) in said group is calculated only using additions ((P+T)+(P−T)) by adding a first element (P+T) obtained by adding said element P and another known element T, distinct from P, of said group and a second element (P−T) obtained by subtracting said element T from said element P.

5. Exponentiation method according to claim 1, characterised in that said algebraic group is the multiplicative group of a ring or a body.

6. Exponentiation method according to claim 2, characterised in that said algebraic group is the additive group of a ring or a body.

7. Exponentiation method according to claim 2, characterised in that said algebraic group is the group of points of an elliptic curve.

8. Exponentiation method according to claim 4, applied to public key cryptography and characterised in that the known element (T) is an element of the public key.

9. Exponentiation method according to claim 1, characterised in that is it implemented in an electronic component.

10. Exponentiation method according to claim 9, characterised in that said electronic component is a chip card.
